(19) United States
(12) Patent Application Publication
(10) Pub. No.: US 2007/0233965 A1
(43) Pub. Date: Oct. 4, 2007

(54) Way hint line replacement algorithm for a snoop filter

(76) Inventors: Kai Cheng, Portland, OR (US); Rob Milstrey, Citrus Heights, CA (US); Jeffrey D. Gilbert, Portland, OR (US); Liqun Cheng, Salt Lake City, UT (US); Lily P. Looi, Portland, OR (US); Faye Briggs, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/395,123

(22) Filed: Mar. 31, 2006

(51) Int. Cl. G06F 13/28

(52) U.S. Cl. 711/146

(57) ABSTRACT

A system and method for maintaining data coherency in a multiprocessor environment. The system includes a snoop filter that maintains a representation of the organization and context of each last level cache on the system. The representative is updated with each request which each include a hint to the location where requested data will be stored in the last level cache.

### BACKGROUND

1. Field of the Invention

The invention relates to a system and method for cache coherency management using a snoop filter. Specifically, embodiments of the invention include a replacement algorithm in a snoop filter that maintains a representation of the organization of last level caches in the system.

2. Background

The use of multiple processors or processors with multiple cores has become increasingly common as a method of increasing the computing power of new computer systems. Multiprocessor and multicore systems share system resources such as system memory and storage devices. Multiple processors or cores often access the same data in memory or storage devices and attempt to utilize this data at the same time. To accomplish this, multiprocessor and multicore systems track the use of data to maintain data coherency. One facet of maintaining data coherency in multiprocessor systems is ensuring that data cached in each processor is coherent. For example, each processor may alter data in its cache before writing it back to system memory. If another processor requests this data from system memory before the altered data is written back to memory, data coherency is lost.

A common scheme for maintaining data coherency in these systems includes a snoop filter in a hub controller. The conventional snoop filter maintains a cache of data requests from each processor or core to track the contents of the cache of each processor or core. Each time a processor retrieves data from memory, an indicator or tag for that data is stored in the snoop filter cache. However, the snoop filter is not aware of cache entries that have been dropped by a processor or core. As a result, the snoop filter cache may become full of entries for data that is no longer in use by the processor. As a result of the snoop filter may have to drop a cache entry that is still in use when a new request is received from a processor or core.

The replacement algorithm of the snoop filter randomly chooses an entry in the snoop filter cache to be dropped to make room for the new entry. This causes an invalidation message to be sent to the processor or core for the dropped entry. However, if the dropped entry is still in use, the processor or core will request the entry again. This generates additional traffic on the bus between processor or core and the hub controller, thereby reducing the available bandwidth for other data transfers.

To minimize the effect of this process on the bandwidth of the bus and the utilization of the processor, the snoop filter caches are larger than the respective caches in the processors which they track. The snoop filter cache size may be four to eight times larger than the total size of the caches of the processors or cores in the system. These large snoop filters occupy a large amount of space and increase the complexity and consequently the cost of hub controllers.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a system including a way hint snoop filter.

FIG. 2 is a diagram of one embodiment of a way hint snoop filter.

FIG. 3A is a diagram of one embodiment of an affinity in a way hint snoop filter.

FIG. 3B is a diagram of one embodiment of a cache entry in the way hint snoop filter.

FIG. 4 is a flow chart of one embodiment of a process for cache management based on way hints.

FIG. 5A is a diagram of one example of a cache management process.

FIG. 5B is a diagram of one example of a cache management process.

FIG. 5C is a diagram of one example of a cache management process.

FIG. 5D is a diagram of one example of a cache management process.

### DETAILED DESCRIPTION

In the following description, numerous specific details are set forth. However, it is understood that embodiments of the invention may be practiced without these specific details. In other instances, well-known, circuits, structures and techniques have not been shown in detail in order not to observe the understanding of this description.

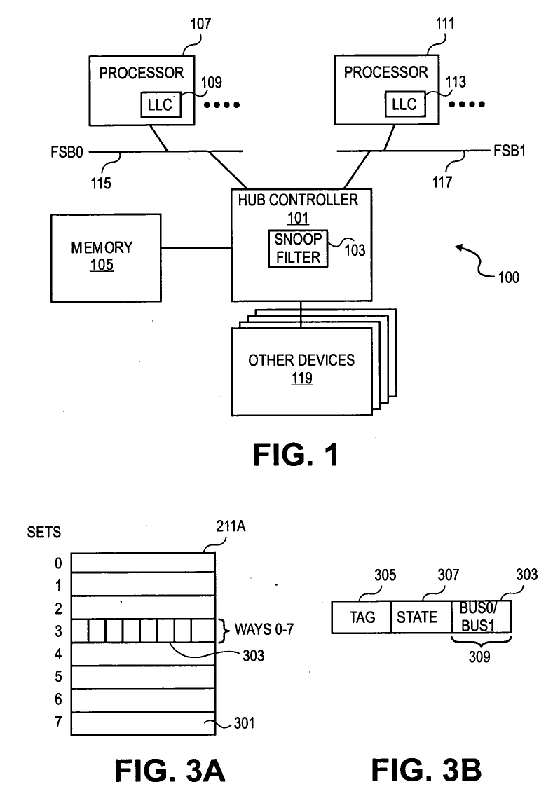

FIG. 1 is a diagram of one embodiment of a system with a ‘way hint’ snoop filter. The system 100 may be any type of multiprocessor or multicore system including a personal computer, mainframe computer, handheld computer, consumer electronic device (cellular phone, handheld gaming device, or similar device), network device or other similar devices.

The system 100 may have any number of processors 107, 111 each having at least one cache 109, 113 associated with the processor 107, 111. In one embodiment, the system 100 may have a fixed number of processors 107, 111. In another embodiment, the system 100 may have slots or interfaces for any number of processors. The number of processors may be changed by adding or removing processors from the system.

In one embodiment, the processors 107, 111 may be processors with separate cores and on separate substrates and in separate packages. In another embodiment, the processors may contain multiple cores on a single substrate and chip package or combinations thereof. For sake of convenience in description, the example system described is a multiprocessor personal computer system. Each processor 107, 111 may have a group of caches. As used herein, “a group” may denote any number of items including one. For example, a processor may have a level 1 cache as well as a level 2 cache. The highest level cache may be referred to as a last level cache (LLC).

Each processor 107, 111 may be in communication with a hub controller 101 through a bus 115, 117. The hub controller 101 may be a device or chipset that manages the movement of data between the processors 107, 111 and system memory 105 as well as other devices 119 in the system 100. In one embodiment, a single hub controller 101 may be present in the system 100. In another embodiment, multiple hub controllers may be present or the hub controller 101 may be subdivided into multiple components. For example, some personal computer systems have two hub controllers referred to as a north bridge and a south bridge.

In one embodiment, the hub controller 101 may communicate to each processor 107, 111 over a separate bus 115, 117. In other embodiments, the multiple processors may communicate over a single bus or may share a subset of the buses. The buses 115, 117 between the processors 107, 111 and the hub controller 101 may be referred to as front side buses (FSBs).

In one embodiment, the system memory 105 may be any type of dynamic random access memory (DRAM) device or group of memory devices. For example system memory 105 may include synchronous DRAM, dual data rate DRAM and similar types of memory devices. The system memory 105 may be used to store data and program instructions for use by the processors 107, 111. In another embodiment, the system memory may be a static memory device, flash memory device or similar memory device such as an electronically erasable programmable read only memory (EEPROM), memory stick or similar device.

Other devices 119 that may be in communication with the system 100 may include network devices and cards, graphics devices, large storage devices such as hard disk drives, removable storage devices such as compact disc (CD) and digital versatile disc (DVD) drives and similar devices. The presence of these devices may vary depending on the type of device of which the system 100 is a part. For example, if the system is a network device then multiple network cards or communication devices may be present, but graphics devices such as graphics cards and monitors may be absent.

In one embodiment, the multiprocessor system 100 manages data coherency between processors within the hub controller 101. This may be accomplished through the management of LLC data for each of the processors 107, 111. A snoop filter 103 may participate in the management of data coherence between the processors 107, 111. The snoop filter 103 may maintain a representation of the data stored in each of the LLCs 109, 113, including a representation of the organization of the data in each of the LLCs 109, 113. The snoop filter 103 may monitor requests for data from each processor 107, 111. These data requests, such as read requests, may contain data organization information. The requests and data organization information are used by the snoop filter to maintain a representation of the organization of each of the caches 109, 113 that is up to date.

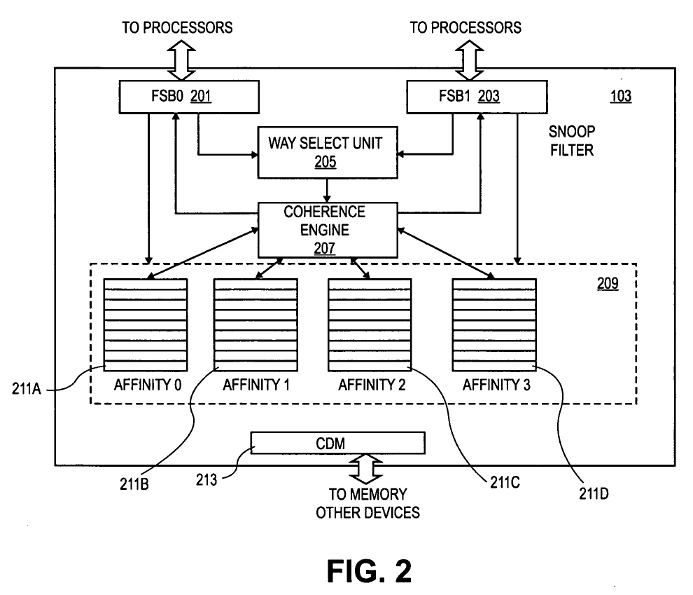

FIG. 2 is a diagram of one embodiment of a snoop filter 103. The snoop filter 103 includes a data storage structure 209. In one embodiment, the data storage structure is a cache such as a set associative cache or similar storage structure. The data storage structure 209 may be organized to represent each of the LLCs of the processors in the system. The data storage structure 209 may be subdivided logically into a group of ‘affinities’. There may be one affinity for each processor in the system. An affinity may be a storage device or a section of the data storage structure 209 that is organized in the same manner as the associated LLC that the affinity represents.

FIG. 3A is a diagram of one embodiment of the structure of an affinity in the data storage structure 204 of the snoop filter 103. Each affinity 211a-211d may include a group of ‘sets.’ A set is type of location indicator that is composed of a group of ‘ways.’ A way is a slot or location indicator of a cache line in a set. Each set may contain any number of ways. In one embodiment, each set may contain eight ways. The number of sets and ways in each affinity may be determined based on the corresponding organization of the LLCs in the processor. The indexing scheme of affinities, sets and ways is one example embodiment. Any other indexing and organizational scheme may be used such that the snoop filter data structure 209 models the organization of each of the LLCs. For sake of convenience, embodiments of the affinity, set and way organization are described. However, other embodiment with other organization schemes may also be utilized.

FIG. 3B is a diagram of one embodiment of a way in the data storage structure 20a. In one embodiment, each way may store data about the corresponding cache entry in the LLC. A way 303 may include tag data 305, state data 307 and bus indicator data 309. The tag data 305 may be data that matches tag data in the cache of the corresponding LLC. For example, tag data 305 may be a portion of an address for a cache line. The state data 307 may be data indicating the status of the cache line in the LLC such as whether the data is exclusive to the processor, shared, invalid, modified or similar status information. The bus indicator data 309, may be a set of bits used to indicate the bus over which the LLC holding the data communicates with the hub controller. The bus indicator data 309 may have a bit corresponding to each bus line available in the system or may encode the bus lines over which the processors communicate with the hub. A cache entry may be present in more than one LLC, such that multiple buses may need to be used to communicate state data related to a cache entry in each of the LLCs.

Returning to the discussion of FIG. 2, the snoop filter 103 may be in communication with each processor through an interface 201, 203 for the respective bus of the processor. In one example, the snoop filter 103 may be in communication with two processors, each having a separate bus. In this example, the snoop filter 103 has a first interface 201 for communicating over the first bus with the first processor and a second interface 203 for communicating with the second processor over a second bus.

Upon receiving a request for data from a processor through a bus interface 201, 203, the request may be parsed or processed to determine a ‘way hint’ provided in the request. A request may be a read request, a request for exclusivity or similar data request. In one embodiment, the request may contain a way number indicating the way location or way hint in which the data being requested will be stored in the LLC of the requesting processor. In another embodiment, other location indication information may be provided dependent on the indexing or organizational model of the LLC.

In one embodiment, the request information may be provided to a coherence engine 207 or may be applied to the data storage structure 209 to determine if the requested data is present in any of the affinities 211a-211b and therefore any of the LLCs of the processors in the system. The results of the search may then be returned to the coherence engine 207. In one embodiment, the search may be conducted by applying the requested tag data to each of the affinities and determining the location in the affinity of any matching tags, utilizing the set associative features of the data storage structure 209. In another embodiment, other search techniques may be utilized.

The coherence engine analyzes the search results along with the way hint, tag data, bus or processor identification information, and set location indication. The set location may be determined by applying the same algorithm for selecting a set that is applied by the corresponding processor and LLC for selecting a set. In this way, set indicator information does not have to be explicitly included in the request data. Any set selection algorithm may be used, including a random selection algorithm, a round robin algorithm or similar algorithm. In another embodiment, the set indicator data or similar data is included in the request.

In one embodiment, the coherence engine 207 analyzes the input data and determines how to forward the request received from the processor, how to update the snoop filter data structure 209 and whether to generate invalidation messages to be sent to the appropriate LLC. Invalidation messages and requests to be forwarded to other processors are then sent to the appropriate bus interface 201, 203. Requests that are forwarded to memory to be completed are sent to the central data manager (CDM) 213. The control data manager 213 is responsible for managing the transfer of data between the hub controller and system memory as well as other devices.

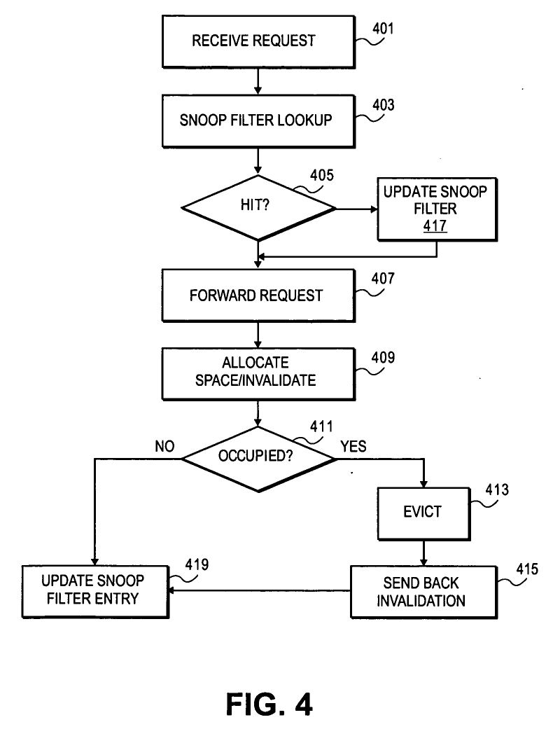

FIG. 4 is a diagram of one embodiment of a process performed by the snoop filter to maintain data coherence. In one embodiment, the process is initiated by receiving a request from a processor (block 401). The request may be a read request, request for exclusivity or similar request for data. The request may be applied to the data structure of the snoop filter to determine if the requested data is present (block 403). The process may be a look up process, search process or similar process.

After the results of the look up process are obtained, the request may be forwarded to the appropriate destination to be fulfilled (block 405). In the case that the requested data is found in the data structure, then the request is forwarded to the processor and cache containing the data. The processor or cache holding the requested data may be indicated in the results of the lookup and determined based on the affinity in which a match to the request is found. In the case that the requested data is not found then the request is forwarded to the system memory to be completed. Similarly, if requested data is found in the data structure but its state information indicates it is invalid, then the request is completed at the system memory.

To accommodate the data to be returned to the requesting processor cache, the representation of the cache maintained by the snoop filter is updated. The representation is updated by allocating space for the new entry. The affinity for updating in response to the request is determined by detecting the bus on which the request was received. The request may also be parsed or processed to determine the way hint or location hint contained within the request. The slot for storing the new entry in the snoop filter is selected based on the way hint provided by the request and by using a set selection algorithm that matches the set selection algorithm of the requesting processor. In this manner, corresponding entries are allotted for the requested data in the cache of the requesting processor and the data structure of the snoop filter. This scheme allows for the data structure to be smaller than a traditional cache and lowers the likelihood of dropping a cache entry in use by the processor and minimizes the use of the bandwidth of the bus between the hub controller, requesting processor and any processor fulfilling a request.

A check is made to determine if the selected space in the cache is occupied (block 409). If the slot is not occupied then the slot is updated to reflect the data being stored in the corresponding space in the requesting processor cache. (block 413). The data is updated in the snoop filter when the request returns from the processor where it is completed or from memory depending on the location of the requested data. If the slot is occupied, the slot is evicted (block 411). The evicted data may be temporarily stored in a buffer until an invalidation message is sent to the originating processor to ensure that the requesting processor does not rely on that data in the case that it was not already invalidated (block 415).

If the data is retrieved from another processor, the entry for that processor may be invalidated by sending an invalidation message to that processor. For example, if a request for exclusivity is received for data in the cache of another processor, then an invalidation message is sent to that processor after the data is received.

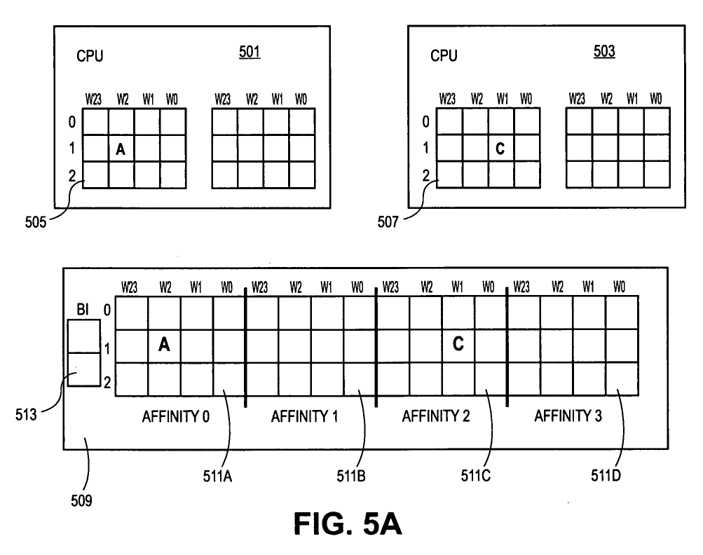

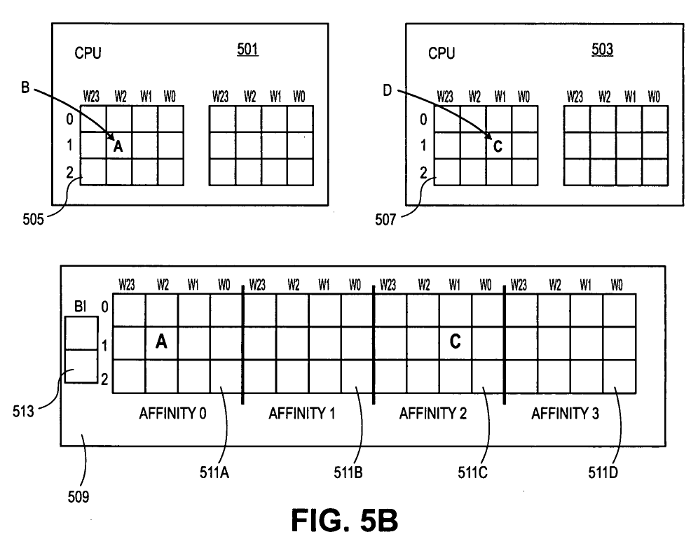

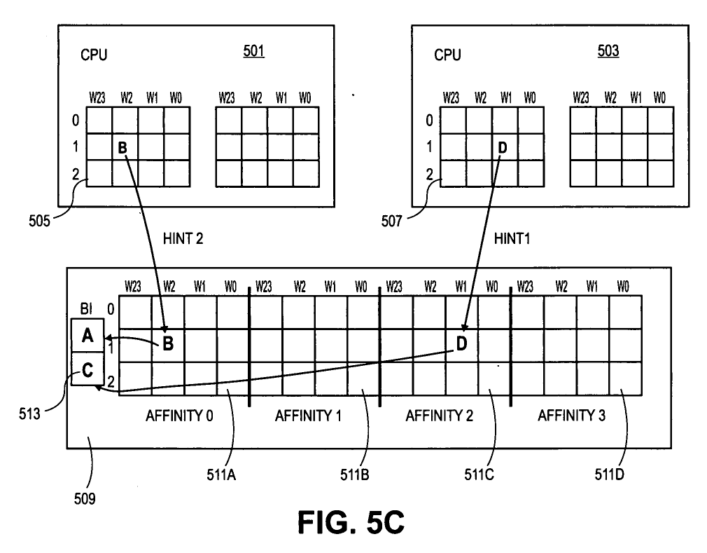

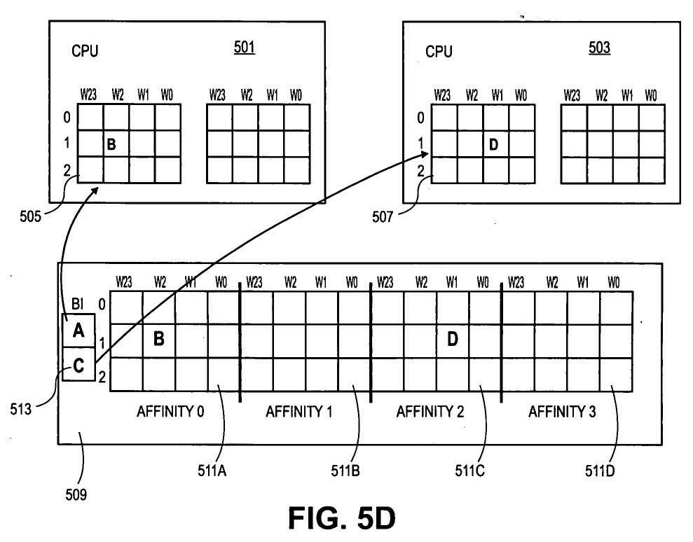

FIGS. 5A-5D are diagrams of an example of the operation of the snoop filter replacement algorithm. In this example, two central processing units (CPUs) are in communication with the snoop filter 509. The two CPUs may be dual core and have multiple caches, one for each core. The snoop filter 509 has a set of corresponding affinities 511A-511D. In this example, affinity 511A corresponds to cache 505 and affinity 511C corresponds to cache 507. In FIG. 5A, cache 505 includes a data item A and cache 507 includes data item C. Affinity 511A, which corresponds to cache 505 includes an indicator of item A in a location corresponding to the location of item A in cache 505, namely set 1, way 2. Similarly, cache 507 includes item C in set 1, way 1. Affinity 511C includes an indicator of item C in corresponding set 1, way 1.

FIG. 5B is a diagram of the example, showing the initiation of a request for data item B by processor 501 and a request for data item D by processor 503. Processor 501 selects set 1, way 2 in which to store the requested item. The selection of this location in the LLC 505 may be based on any algorithm, including a round robin, least recently used, or similar replacement algorithms or combinations thereof. Likewise, the processor 503 selects set 1, way 1 to store requested item D.

FIG. 5C is a diagram of the example, showing the state of the system after the request has been fulfilled. In this case, data items B and D were not present in the snoop filter 509 and were completed at the system memory, resulting in the storage of items B and D in the selected locations in the LLCs 505, 507. Also, the corresponding entries in the affinities 511A, 511C have been updated using the request data provided including the way hints 2 and 1, respectively, and knowledge of the set selection algorithms of each processor 501, 503. The data items A and C that have been evicted are temporarily stored in back invalidation buffer 513.

FIG. 5D is a diagram of the example, showing the sending of back invalidation messages to the processors 501, 503 and LLCs 505, 507. The back invalidation messages for data items A and C may be sent to both processors 501, 503 and LLCs 505, 507 or just the requesting processors unless the data items had been shared between them, in which case both would be sent the back invalidation messages for the shared data item. These messages ensure data coherency in the case that the way hint is not properly determined or the set selection algorithms do not match between the processors 501, 503 and the snoop filter 509. In the example, the data items A and C were properly overwritten and the back invalidations prove to be unnecessary.

In one embodiment, the snoop filter and its components are implemented as hardware devices. In another embodiment, these components may be implemented in software (e.g., microcode, assembly language or higher level languages). These software implementations may be stored on a machine-readable medium. A “machine readable” or “machine accessible” medium may include any medium or mechanism that can store or transfer information in a form accessible by a machine (e.g., a computer network device, personal digital assistant manufacturing tool, any device with one or more processors, etc.). Examples of a machine readable or accessible medium include a recordable non-recordable media, such as read only memory (ROM) random access memory (RAM), magnetic storage media, optical storage media, physical storage media, flash memory, or similar medium.

In the foregoing specification, the embodiments of the invention have been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method of comprising:
maintaining a representation of an organization of a first cache in a first processor within a hub a controller;
receiving a request for data from a second processor; and
checking the representation to determine if the data is present in the first cache.

2. The method of claim 1, wherein checking the representation to determine if the data is present comprises:
applying a first location indicator received from the request to the representation.

3. The method of claim 2, wherein checking the representation to determine if the data is present comprises:
determining a second location indicator based on a method similar to that used by the first processor.

4. The method of claim 2, wherein the first indicator is a way hint.

5. The method of claim 3, wherein the second indicator is a set.

6. The method of claim 1, further comprising:
updating the representation to correspond to the data returned to the first cache.

7. The method of claim 6, wherein updating the representation comprises:
updating tag information at a way and set location corresponding to a way and set location of the data in the first cache.

8. The method of claim 1, further comprising:
sending an invalidation message to the first cache if an eviction of a location in the representation is performed.

9. The method of claim 1, further comprising:
forwarding the read request to the first cache if the data is located in the representation; and
completing the read request at memory if the data is not located in the representation.

10. A device comprising:
a data storage structure organized to represent a first cache of a first processor and a second cache of a second processor; and
a coherency engine to operate upon the data storage structure to maintain data coherence between the first cache and the second cache.

11. The device of claim 10, wherein the data storage structure is a set associative cache.

12. The device of claim 10, wherein an entry in the data storage structure comprises:
tag data;
bus indicator data; and
state data.

13. The device of claim 10, wherein the data storage structure has a way hint input.

14. The device of claim 10, wherein the coherence engine . . . .

15. A system comprising:
a mainboard;
a first processor having a first cache coupled to the mainboard;
a second processor coupled to the mainboard, the second processor having a second cache;
a hub controller coupled to the mainboard, the hub controller in electrical communication with the first processor and the second processor, the hub controller including a snoop filter to manage data coherency between the first cache and the second cache using a representation of an organization of the first cache and the second cache; and
dynamic random access memory coupled to the mainboard to store data to be accessed by the first processor and second processor.

16. The system of claim 15, wherein the snoop filter includes a set associative cache.

17. The system of claim 15, wherein the representation tracks set and way location of data in the first cache and the second cache.

18. The system of claim 15, further comprising:
a first bus to provide communication between the first processor and the snoop filter.

19. The system of claim 18, further comprising:
a second bus to provide communication between the second processor and the snoop filter.

20. The system of claim 15, wherein the first processor generates data requests having a way hint.

21. An article of manufacturing comprising:
a machine-accessible medium including data that, when accessed by a machine, cause the machine to performs operations comprising,
maintaining a representation of an organization of a last level cache in a snoop filter,
analyzing a request for data to be stored in the last level cache, and
updating the representation to include the requested data.

22. The article of manufacture of claim 21, wherein analyzing the request includes detecting a way hint.

23. The article of manufacture of claim 21, wherein updating the representation includes determining a set using an algorithm similar to an algorithm used to select a set in the last level cache.

24. The article of manufacture of claim 21, wherein the representation includes an affinity corresponding to the last level cache.

25. The article of manufacture of claim 21, wherein the machine readable medium further includes data that cause a machine to perform operations comprising:
identify an origin of the request based on a bus carrying the request.
